(19) United States
(12) Patent Application Publication
(10) Pub. No.: US 2026/0127458 A1
(43) Pub. Date: May 7, 2026

(54) VISUAL ARGUMENTATION REASONING DEVICE AND METHOD

(71) Applicant: UIF (University Industry Foundation), Yonsei University, Seoul (KR)

(72) Inventors: Youngjae YU, Seoul (KR); Jiwan CHUNG, Seoul (KR)

(73) Assignee: UIF (University Industry Foundation), Yonsei University, Seoul (KR)

(21) Appl. No.: 19/090,691

(22) Filed: Mar. 26, 2025

(30) Foreign Application Priority Data
Nov. 6, 2024 (KR) 10-2024-0156314

(51) Int. Cl. G06N 5/04

(52) U.S. Cl. CPC G06N 5/04

(57) ABSTRACT

The present disclosure relates to a visual argumentation reasoning device, comprising: a visual premise unit (VPU) that receives an image and detects an argumentation premise from the image to decide a visual premise; a commonsense premise unit (CPU) that extracts at least one piece of background knowledge associated with the visual premise to decide a commonsense premise; and a conclusion derivation unit that derives at least one intermediate conclusion based on the commonsense premise and the visual premise and derives a final conclusion through a logical association with the at least one intermediate conclusion.

### CROSS-REFERENCE TO RELATED PATENT APPLICATION

This application claims the benefit of Korean Patent Application No. 10-2024-0156314, filed on Nov. 6, 2024, in the Korean Intellectual Property Office, the disclosure of which is incorporated herein in its entirety by reference.

### TECHNICAL FIELD

The present disclosure relates to a visual argumentation reasoning technique, and more specifically, to a visual argumentation reasoning device and method capable of deriving at least one intermediate conclusion based on commonsense premises and visual premises and capable of deriving a final conclusion through a logical association with the at least one intermediate conclusion.

### BACKGROUND

Commonsense-based reasoning is artificial intelligence technology that helps computers understand commonsense naturally and interact based thereon by finding methods to collect commonsense and teach the same to the computers.

The four stages of commonsense-based reasoning technology are as follows:

In a commonsense extraction stage, commonsense information may be expressed in the form of an ontology (expressing various concepts such as relationships between objects in a form that may be processed by computers) or a graph from various data sources such as text corpora, web documents, videos, and crowdsourcing.

In a commonsense verification stage, the constructed commonsense information may be verified through question-and-answer with people such as experts.

In a data construction stage for learning, training data for training a commonsense reasoning model from data sources and benchmark data used for verification may be configured.

In a commonsense reasoning stage, a deep learning and probability-based reasoning model may be trained, or a situation that changes in commonsense according to a specific event may be defined as a standardized rule, and then commonsense and appropriate answers to questions may be provided.

Research is actively underway to construct standardized commonsense from various sources and benchmark data for its reasoning.

Korean Patent Application Publication No. 10-2010-0031039 (Mar. 19, 2010) discloses that: When job groups and value systems that function in society are filtered through a filter called history, they have the potential to positively contribute to social design. However, the determination of whether such potential is realized is not made by each job group and value system itself. This is possible when a network of various job groups and value systems is secured to suit the problem-solving context. The person who may work on such a network is the one with organizational thinking ability, and the purpose of various aptitude evaluation tests is to select such person. The aspect of the present disclosure is directed to providing a learning system for training organizational thinking ability, which is an essential competency to be possessed by talented people in such a modern society. The aspect of the present disclosure is achieved by a method for efficiently analyzing an argument structure of a character like an organic body by devising a visual patternization and manipulation method of the argument structure. In summary, the present disclosure relates to an argument analysis learning system in which an operation method of using a visualization tool suitable for a problem solver in an implicit manner is devised based on a visualization tool of argument structure patterns, a quasi-rule for each type, and cases to which the visualization tool and the quasi-rule are applied.

### RELATED ART DOCUMENT

### Patent Document

Korean Patent Application Publication No. 10-2010-0031039, Mar. 19, 2010

### SUMMARY

An embodiment of the present disclosure provides a visual argumentation reasoning device and method capable of inputting an image and detecting argumentation premises from the image to decide visual premises.

An embodiment of the present disclosure provides a visual argumentation reasoning device and method capable of deciding a commonsense premise by extracting at least one piece of background knowledge associated with the visual premises.

An embodiment of the present disclosure provides a visual argumentation reasoning device and method capable of deriving at least one intermediate conclusion based on commonsense premises and visual premises and capable of deriving a final conclusion through a logical association with the at least one intermediate conclusion.

According to embodiments, the visual argumentation reasoning device includes: a visual premise unit (VPU) that receives an image and detects an argumentation premise from the image to decide a visual premise; a commonsense premise unit (CPU) that extracts at least one piece of background knowledge associated with the visual premise to decide a commonsense premise; and a conclusion derivation unit that derives at least one intermediate conclusion based on the commonsense premise and the visual premise and derives a final conclusion through a logical association with the at least one intermediate conclusion.

The visual premise unit may detect an object from the image and decide an argumentation premise object by determining whether the detected object may be used as the argumentation premise.

The visual premise unit may evaluate a possibility of the argumentation premise based on at least one of a shape, color, size, and texture features of the detected object.

The visual premise unit may evaluate the possibility of the argumentation premise based on an object disposition relationship considering a location of the detected object within the image.

The visual premise unit may evaluate the possibility of the argumentation premise based on whether the detected object includes text or symbols.

The visual premise unit may decide the visual premise by performing semantic clustering through analyzing a similarity to the argumentation premise object.

The commonsense premise unit may generate a textual representation of the visual premise and extract candidate background knowledge by searching the textual representation in a knowledge base.

The commonsense premise unit may evaluate logical validity of the candidate background knowledge for the visual premise to decide the at least one piece of background knowledge.

The commonsense premise unit may decide the commonsense premise by calculating correlation of the visual premise to each of the at least one piece of background knowledge.

The conclusion derivation unit may decide a logical order of the at least one intermediate conclusion and perform selection and ruling out of the at least one intermediate conclusion in a process of deciding the logical order to integrate the at least one intermediate conclusion.

According to embodiments, a visual argumentation reasoning method performed by the visual argumentation reasoning device includes: a visual premise stage that receives an image and detects an argumentation premise from the image to decide a visual premise; a commonsense premise stage that extracts at least one piece of background knowledge associated with the visual premise to decide a commonsense premise; and a conclusion derivation stage that derives at least one intermediate conclusion based on the commonsense premise and the visual premise and derives a final conclusion through a logical association with the at least one intermediate conclusion.

### Advantageous Effects

The disclosed technology can have the following benefits. However, it does not mean that a specific exemplary embodiment should include the entire following benefits or should include only the following benefits, and it should not be understood that the scope of right of the disclosed technology is limited thereto.

A visual argumentation reasoning device and method according to an embodiment of the present disclosure can receive an image and detect an argumentation premise from the image to decide a visual premise.

The visual argumentation reasoning device and method according to an embodiment of the present disclosure can extract at least one piece of background knowledge associated with the visual premise to decide a commonsense premise.

The visual argumentation reasoning device and method according to an embodiment of the present disclosure can derive at least one intermediate conclusion based on the commonsense premise and the visual premise and derive a final conclusion through a logical association with the at least one intermediate conclusion.

### BRIEF DESCRIPTION OF THE DRAWINGS

FIG. 1 is a diagram illustrating a visual argumentation reasoning device according to an embodiment of the present disclosure.

FIG. 2 is a diagram illustrating a system configuration of the visual argumentation reasoning device of FIG. 1.

FIG. 3 is a flowchart illustrating a visual argumentation reasoning method according an embodiment of the present disclosure.

FIG. 4 is a diagram illustrating a human worker repeatedly improving machine-generated initial data in a VisArgs annotation process according an embodiment of the present disclosure.

FIG. 5 is a diagram illustrating the diversity of topics appearing in visual premises and conclusions in human VisArgs according an embodiment of the present disclosure.

FIG. 6 is a diagram illustrating a case of premise identification failure of LLaVA-1.5 according to an embodiment of the present disclosure.

FIG. 7 is a diagram illustrating (left) an OCR detection result and (right) an actual text instance (highlighted in red) missed by a model according to an embodiment of the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

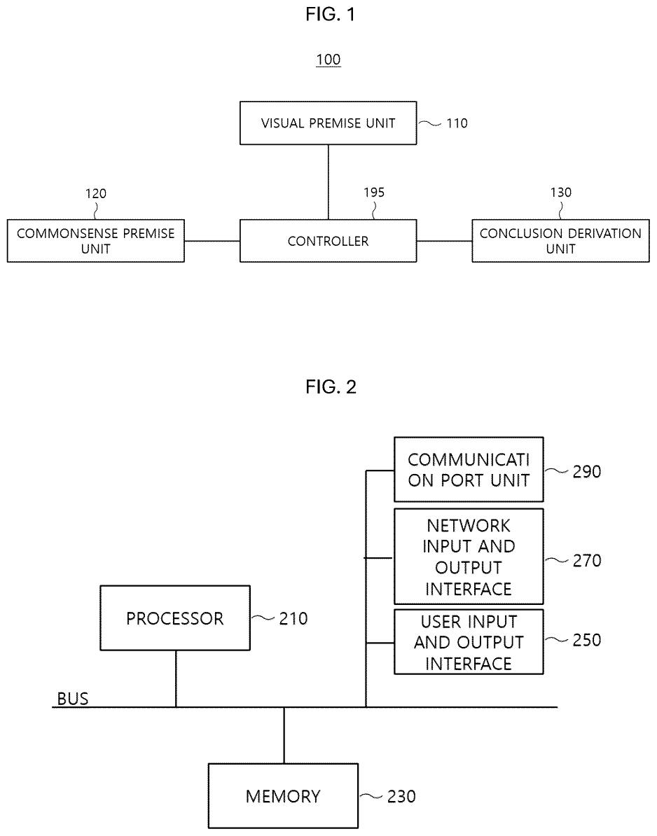

FIG. 1 is a diagram illustrating a visual argumentation reasoning device according to an embodiment of the present disclosure.

Referring to FIG. 1, a visual argumentation reasoning device 100 may include a visual premise unit 110, a commonsense premise unit 120, and a conclusion derivation unit 130.

The visual premise unit 110 may receive an image and detect an argumentation premise from the image to decide a visual premise.

More specifically, the operation of the visual premise unit 110 is as follows.

The visual premise unit 110 may receive an image from an external source. The image may include visual argumentation and may contain visual information necessary to derive the conclusion of argumentation.

The visual premise unit 110 may analyze and extract major visual elements related to the argumentation from the input image for premise detection. For example, when the image visually represents the issue of climate change, a polar bear and melting ice may be detected as major visual premises.

The visual premise unit 110 may identify a portion of the detected visual elements that may be used as a premise for the argumentation for premise classification and decision, and decide the final visual premise based thereon. In this connection, the visual premise unit 110 may configure the visual premise by considering the role of each element in the image in the argumentation.

The visual premise unit 110 may output the finally decided visual premise so as to be utilized in an argumentative structure or may be transferred to a subsequent reasoning unit.

The visual premise unit 110 may detect objects in the image and determine whether the detected objects may be used as argumentation premises to decide argumentation premise objects.

More specifically, the visual premise unit 110 may identify and detect various objects in the input image. At this stage, the visual premise unit 110 may find meaningful objects in the image by utilizing an object detection algorithm or a deep learning-based image recognition technology. For example, when it is an image that visually argues the issue of climate change, elements such as a polar bear, ice, and the sea may be detected as objects.

The visual premise unit 110 may determine whether the detected objects may be used as argumentation premises. In this process, the visual premise unit 110 may analyze whether each object contains a meaning related to the argumentation and evaluate whether each object may contribute to the core message of the argumentation. For example, the visual premise unit 110 may determine a polar bear standing on ice as an argumentation premises object suitable for expressing the impact of climate change.

The visual premise unit 110 may finally select an object that may be used in the argumentation and decide the same as an argumentation premise object. In this decision stage, the visual premise unit 110 may comprehensively consider the location, size, and visual emphasis of each object to select the most important object. Hence, the visual premise unit 110 may configure a premise object that may clearly convey the argumentation.

The visual premise unit 110 may transfer the finally decided argumentation premise object to the commonsense premise unit (CPU) or the conclusion derivation unit, thereby contributing to forming the flow of the argumentation thereafter.

The visual premise unit 110 may evaluate the possibility of the argumentation premise based on at least one of the shape, color, size, and texture features of the detected object.

More specifically, the visual premise unit 110 may analyze the visual features of the detected object. The visual features may include major visual elements such as shape, color, size, and texture. For example, when the visual premise unit 110 detects a polar bear in a specific image, the size (size compared to ice), color (white), and surface texture (fur) of the polar bear may be analyzed as major features.

The visual premise unit 110 may evaluate how each visual feature is related to the argumentation premise. At this stage, the visual premise unit 110 may determine whether the shape, size, or color of an object may play an important role in conveying an argumentation message. For example, the visual premise unit 110 may evaluate that the large body and white fur of the polar bear symbolize its habitat in a natural environment, and that its appearance on a small piece of melting ice is a visual premise suitable for expressing the severity of climate change.

When evaluating the possibility that the detected object contributes to the argumentation premise, the visual premise unit 110 may decide the importance of specific visual features to decide the suitability with the argumentation message. For example, the color red may be effective in conveying urgency or warning, and large objects may be visually emphasized to clearly convey the argumentation message.

The visual premise unit 110 may select an object suitable for the argumentation premise through visual feature analysis and evaluation. This selection process is reflected in a subsequent argumentation configuration and a conclusion derivation process, and may be configured to convey the argumentation message more effectively.

The visual premise unit 110 may evaluate the possibility of the argumentation premise based on the object disposition relationship considering the location of the detected object in the image.

More specifically, the visual premise unit 110 may collect location information of the objects detected in the image. The location of each object may be expressed as relative or absolute coordinates in the image, and thus the visual premise unit 110 may understand where the object is located in the image. For example, the location relationship may be defined such as a cloud at the top of the image, a polar bear in the center, and ice at the bottom.

The visual premise unit 110 may analyze the disposition relationship between the detected objects. In this process, the visual premise unit 110 may evaluate how each object is connected in the argumentation by considering the relative distance, direction, and size ratio between objects. For example, when a polar bear is located on a small piece of ice, the visual premise unit 110 may determine that the disposition relationship may reinforce the visual message that the habitat of polar bears is reducing.

The visual premise unit 110 may apply the location and disposition relationship of the object as important factors in evaluating the suitability with the argumentation premise. The visual premise unit 110 may analyze whether a specific object is located in a location that may contribute to conveying the core message of the argumentation and whether the location relationship with other objects provides logical connectivity. For example, in an image where the sea and a factory chimney are disposed, pollutants from the factory chimney may be expressed as flowing into the sea, thereby emphasizing climate change or pollution issues.

The visual premise unit 110 may finally select the argumentation premise object based on the result of the argumentation premise possibility evaluation considering the location and disposition relationship. These selections may play an essential role in constructing the subsequent logical flow, and may contribute to increasing the clarity and persuasiveness of the argumentation.

The visual premise unit 110 may evaluate the possibility of the argumentation premise based on whether the detected object includes text or a symbol.

More specifically, the visual premise unit 110 may check whether the object detected in the image includes text (letters, numbers, or the like) or a symbol (icon, symbol, or the like). For example, the visual premise unit 110 may detect visual symbols such as phrases displayed on a traffic sign, prohibition signs, or warning icons. At this stage, the visual premise unit 110 may use optical character recognition (OCR) technology or a symbol recognition algorithm to recognize text and symbols included within the object.

The visual premise unit 110 may evaluate whether the text and symbols may contribute to the argumentation message. The visual premise unit 110 may increase the suitability as an argumentation premise by reinforcing the argumentation of a specific phrase or symbol or clearly conveying its meaning. For example, when an image includes the phrase “STOP POLLUTION,” this phrase may be evaluated as an important element that strengthens the visual argumentation for environmental protection.

The location and size of the detected text or symbol in the visual premise unit 110 may also be applied as important elements in evaluating the possibility of the argumentation premise. When the text or symbol is located in the center of the image or is large in size, this element may be effective in conveying the core message of the argumentation. For example, a warning symbol displayed large in the center of the image may increase attention and strengthen the possibility as an argumentation premise.

The visual premise unit 110 may finally evaluate the possibility that the object will be used as an argumentation premise based on the presence or absence of text and symbols and their characteristics. When the object including the text or symbol is able to clearly convey the argumentation message and contribute to enhancing persuasiveness, the visual premise unit 110 may select the corresponding object as the final argumentation premise.

The visual premise unit 110 may decide the visual premise by performing semantic clustering through analyzing a similarity to the argumentation premise object.

More specifically, the visual premise unit 110 may analyze the features of each detected argumentation premise object to evaluate similarity. The visual premise unit 110 may comprehensively analyze the shape, color, size, texture, and visual meaning or role of the object. For example, when there are ice chunks of various sizes, these ice chunks may be analyzed as the same semantic category because of similar shapes and colors.

The visual premise unit 110 may group semantically associated objects into one cluster based on similarity. Thus, the visual premise unit 110 may group objects that play a similar role in the argumentation to form a more consistent premise. For example, in an image with a polar bear and several ice chunks, the ice chunks may be grouped into one cluster to play the role of a premise of habitat reduction due to climate change.

The visual premise unit 110 may evaluate whether each generated cluster may contribute to the argumentation message. When a particular cluster is closely associated with the topic of the argumentation and has an important meaning in conveying the message, the corresponding cluster may have value as an argumentation premise. For example, in an argumentation related to climate change, a cluster of ice chunks may play a role in visually conveying an important premise of habitat reduction.

The visual premise unit 110 may comprehensively evaluate the meaning of each cluster and ultimately decide the visual premise to be used in the argumentation. A premise formed through semantic clustering may convey a stronger message than a single object, thus contributing to increasing the persuasiveness of the argumentation. For example, when ice chunks of various sizes are expressed as a cluster, this expression may serve as a visual premise that may more strongly convey the severity of climate change.

The commonsense premise unit 120 may extract at least one piece of background knowledge associated with the visual premise to decide a commonsense premise.

More specifically, the operation of the commonsense premise unit 120 is as follows.

The commonsense premise unit 120 may receive the visual premise detected from a VPU. For example, when the visual premise that “a polar bear is on melting ice” is detected in the image, this information may be input to the CPU.

The commonsense premise unit 120 may extract background knowledge associated with the visual premise. This may supplement the visual premise by utilizing commonsense that humans presently know. For example, commonsense information such that “climate change is melting the ice in the Arctic” may be included.

The commonsense premise unit 120 may decide a commonsense premise that may complete the flow of the argumentation based on the extracted background knowledge. This commonsense premise may play an important role in deriving a conclusion of argumentation that is not clear only with the visual premise. For example, “the habitat of polar bears is threatened due to climate change” may be decided as a commonsense premise.

The commonsense premise unit 120 may form the logical flow of the entire argumentation by combining the decided commonsense premise with the visual premise during the argumentation process. Thereafter, these commonsense premises may be transferred to the subsequent reasoning department to contribute to deriving the final conclusion.

The commonsense premise unit 120 may generate textual representations of visual premises and extract candidate background knowledge by searching the textual representations in the knowledge base.

More specifically, the commonsense premise unit 120 may convert the visual premises into linguistic forms to generate textual representations. For example, when a situation in which a polar bear is standing on melting ice is detected as a visual premise in an image, the commonsense premise unit 120 may convert this premise into a textual representation such as “a polar bear on melting ice.”

The commonsense premise unit 120 may search the generated textual representations in the knowledge base to extract background knowledge associated with the corresponding premise. The knowledge base is a database containing general commonsense or domain-specific information, and is structured to quickly find related commonsense information. For example, when a textual representation such as “melting ice” is entered, the commonsense premise unit 120 may search for background knowledge including information related to climate change or global warming.

The commonsense premise unit 120 may extract candidate background knowledge that is likely to be useful for the flow of argumentation from among the many pieces of background knowledge that are retrieved as a result of the knowledge base search. The commonsense premise unit 120 may preferentially select items that are directly associated with the visual premise among the searched information, thereby excluding unnecessary information and supporting efficient argumentation configuration. For example, the commonsense premise unit 120 may select a commonsense premise such as “ice in the Arctic is melting due to climate change” as a candidate.

The commonsense premise unit 120 may evaluate whether the extracted candidate background knowledge is suitable as an argumentation premise. The commonsense premise unit 120 may select background knowledge that is consistent with the meaning of the textual representation, thereby leaving information that may strengthen the consistency and logical flow of the argumentation. The commonsense premise unit 120 may filter out redundant or unnecessary information as needed and maintain only information related to the core message of the argumentation.

The commonsense premise unit 120 may finally decide suitable background knowledge as a commonsense premise and transfer the same to the subsequent argumentation stage to contribute to deriving a conclusion. For example, the commonsense premise unit 120 may select the sentence “Climate change has a negative impact on the habitat of the Arctic” as the final commonsense premise.

The commonsense premise unit 120 may evaluate the logical validity of candidate background knowledge for the visual premise and decide at least one piece of background knowledge.

More specifically, the commonsense premise unit 120 may collect several pieces of candidate background knowledge related to the visual premise provided by the VPU through a knowledge base search. For example, the commonsense premise unit 120 may include information such as “Climate change is melting the Arctic ice” and “Industrial pollution is contributing to global warming” as candidate background knowledge associated with the visual premise that “Polar bears on melting ice.”

The commonsense premise unit 120 may set logical validity criteria for evaluating candidate background knowledge. This criteria may include direct association with the visual premise, suitability for the purpose of the argumentation, and semantic consistency. Thus, the commonsense premise unit 120 may preferentially select background knowledge that may be logically connected to the visual premise.

The commonsense premise unit 120 may evaluate logical validity by comparing each piece of candidate background knowledge with the visual premise. For example, the background knowledge that “Climate change is melting the Arctic ice” is logically consistent with the premise “Polar bears on melting ice” and may be suitable for emphasizing the issue of climate change in the argumentation. On the other hand, the commonsense premise unit 120 may exclude background knowledge that has low interrelationship or does not contribute to the flow of argumentation.

The commonsense premise unit 120 may select background knowledge with high logical validity as the final commonsense premise. This background knowledge may be combined with the visual premise to strengthen the message of the entire argumentation and may act as an important link in the argumentative structure. For example, the commonsense premise unit 120 may finally select background knowledge such as “climate change is threatening the habitat of polar bears.”

The commonsense premise unit 120 may transfer the final commonsense premise to the next stage of the conclusion derivation unit, thereby ensuring the consistency and logical completeness of the premise.

The commonsense premise unit 120 may decide the commonsense premise by calculating the correlation of the visual premise for each of at least one piece of background knowledge.

More specifically, the commonsense premise unit 120 may search and collect a plurality of pieces of candidate background knowledge related to the visual premise from the knowledge base. For example, the commonsense premise unit 120 may collect background knowledge such as “Climate change is melting the Arctic ice” and “The impact of global warming on the Arctic environment” as candidates associated with the visual premise of “A polar bear standing on melting ice.”

The commonsense premise unit 120 may set criteria for evaluating the correlation between the visual premise and each piece of background knowledge. Major criteria may include semantic similarity, logical suitability, and consistency with the argumentation topic. These criteria may help to numerically evaluate how strongly each piece of background knowledge is associated with the visual premise.

The commonsense premise unit 120 may calculate the correlation with the visual premise for each piece of candidate background knowledge. For example, the commonsense premise unit 120 may utilize an algorithm that measures semantic similarity to evaluate whether background knowledge such as “Climate change is melting the Arctic ice” has high correlation with the visual premise. The higher the correlation, the more likely it is that the background knowledge is suitable for the argumentation.

The commonsense premise unit 120 may select the background knowledge with the highest correlation as the final commonsense premise based on the calculated correlation. This commonsense premise may be combined with the visual premise to reinforce the core message of the argumentation and play a role in increasing the consistency and persuasiveness of the entire argumentation. For example, when the background knowledge with the highest correlation is “climate change has a negative impact on the habitat of polar bears,” the commonsense premise unit 120 may select this background knowledge as the final commonsense premise.

The commonsense premise unit 120 may integrate the finally decided commonsense premise into the argumentative structure and transfer the same to the conclusion derivation unit. The CPU may support the argumentation to be conveyed clearly based on this commonsense premise.

The conclusion derivation unit 130 may derive at least one intermediate conclusion based on the commonsense premise and the visual premise, and may derive the final conclusion through the logical association with the at least one intermediate conclusion.

More specifically, the operation of the conclusion derivation unit 130 is as follows.

The conclusion derivation unit 130 may receive a visual premise generated from the VPU and a commonsense premise generated from the CPU. Each of these premises forms the basis of argumentation and may be used to derive a conclusion following a logical flow.

The conclusion derivation unit 130 may generate an intermediate conclusion based on the input visual premise and commonsense premise. For example, when the visual premise is “a polar bear is on melting ice” and the commonsense premise is “climate change is melting ice,” the intermediate conclusion such that “the habitat of polar bears is endangered due to climate change” may be derived.

The conclusion derivation unit 130 may analyze the logical relationship between each intermediate conclusion when multiple intermediate conclusions are generated to maintain the consistency of the conclusion. Thus, each intermediate conclusion may be made to work in a complementary manner to form the structure of the entire argumentation.

The conclusion derivation unit 130 may derive a final conclusion through a logical connection between the intermediate conclusions. This conclusion is directly related to the goal of the argumentation, and may be a specific and practical conclusion, for example, “Industrial pollution should be reduced.”

The conclusion derivation unit 130 may clearly express what the visual argumentation aims to achieve by conveying the derived final conclusion to a user or other elements of the system.

The conclusion derivation unit 130 may decide the logical order of at least one intermediate conclusion and perform selection and ruling out of the at least one intermediate conclusion in the process of deciding the logical order to integrate the at least one intermediate conclusion.

More specifically, the conclusion derivation unit 130 may receive multiple intermediate conclusions derived from the commonsense premise and the visual premise. For example, the conclusion derivation unit 130 may receive intermediate conclusions such as “climate change melts ice” or “melting ice reduces the habitat of polar bears.”

The conclusion derivation unit 130 may set criteria to decide the logical order of the intermediate conclusions. These criteria may include causal relationships between intermediate conclusions, logical flow, and clarity of message. Thus, the conclusion derivation unit 130 may enable the conclusion to be conveyed persuasively.

The conclusion derivation unit 130 may analyze the logical relationship between each intermediate conclusion and decide the logical order. For example, the conclusion derivation unit 130 may configure the logical order so that “climate change melts ice” comes first, followed by the conclusion “melting ice reduces the habitat of polar bears.” Thus, the conclusion derivation unit 130 may form a structure in which the intermediate conclusions may derive conclusions in stages.

The conclusion derivation unit 130 may rule out redundant or unnecessary intermediate conclusions in the process of deciding the logical order, and select only the intermediate conclusions necessary to clearly convey the core message. This stage is important to maintain the clarity and conciseness of the conclusion. For example, the conclusion derivation unit 130 may rule out the intermediate conclusion, “climate change leads to global warming,” that is unnecessarily repeated.

Once the logical order and essential intermediate conclusions are decided, the conclusion derivation unit 130 may provide a basis for integrating the same to derive the final conclusion. These final intermediate conclusions may be combined in a complementary manner to increase the completeness of the argumentation and provide a clear logical flow leading to the final conclusion.

The conclusion derivation unit 130 may generate a final conclusion that meets the purpose of the argumentation based on the integrated intermediate conclusions.

FIG. 2 is a diagram illustrating a system configuration of the visual argumentation reasoning device of FIG. 1.

Referring to FIG. 2, the visual argumentation reasoning device 100 may include a processor 210, a memory 230, a user input and output interface 250, a network input and output interface 270, and a communication port unit 290.

The processor 210 may receive a question consisting of an image and text through a text-only language model and a vision-language model, generate a text response and a multimodal response to the question, manage the memory 230 that is read or written in the process, and schedule a synchronization time between a volatile memory and a non-volatile memory in the memory 230. The processor 210 may control the overall operations of the visual argumentation reasoning device 100, and is electrically connected to the memory 230, the user input and output interface 250, the network input and output interface 270, and the communication port unit 290 to control the data flow therebetween. The processor 210 may be implemented in the form of a central processing unit (CPU) or a graphics processing unit (GPU) of the visual argumentation reasoning device 100.

The memory 220 may be implemented in the form of a non-volatile memory such as a solid state disk (SSD) or a hard disk drive (HDD). The memory 220 may include an auxiliary memory used to store overall data necessary for the visual argumentation reasoning device 100 and may include a main memory implemented in the form of a volatile memory, such as a random access memory (RAM). In addition, the memory 230 may store a set of instructions that execute the role of the visual argumentation reasoning device 100 according to an embodiment of the present disclosure by being executed by the electrically connected processor 210.

The user input and output interface 250 may include an environment for receiving a user input or an environment for outputting specific information to a user. For example, the user input and output interface 250 may include an input device including an adapter, such as a touch pad, a touch screen, an on-screen keyboard, and a pointing device, and may include an output device including an adapter, such as a monitor and a touch screen. In an embodiment, the user input and output interface 250 may correspond to a computing device being accessed through a remote access, and, in this connection, the visual argumentation reasoning device 100 may serve as an independent server.

The network input and output interface 270 may provide a communication environment for connecting to an attack IP terminal or a test IP terminal through a network and include an adaptor for communication through, for example, a local area network (LAN), a metropolitan area network (MAN), a wide area network (WAN), and a value added network (VAN). In addition, the network input and output interface 270 may be implemented to provide a short-range communication function through Wi-Fi or Bluetooth networks or a wireless communication function involving 4G or higher communication specifications for wireless transmission of data.

The communication port unit 290 is a hardware interface for connecting to external hardware. For example, the external hardware may include a printer, a mouse, and USB hardware. The communication port unit 290 may sense the connection of specific USB hardware and perform the role of a CTI augmented device 130.

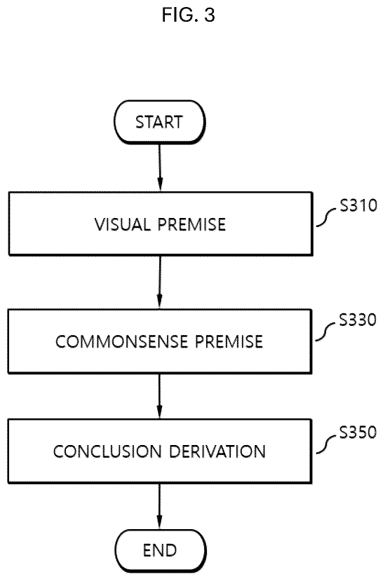

FIG. 3 is a flowchart illustrating a visual argumentation reasoning method according an embodiment of the present disclosure.

In FIG. 3, the visual argumentation reasoning device 100 performs: a visual premise stage that receives an image and detects an argumentation premise from the image to decide a visual premise (stage S310); a commonsense premise stage that extracts at least one piece of background knowledge associated with the visual premise to decide a commonsense premise (stage S330); and a conclusion derivation stage that derives at least one intermediate conclusion based on the commonsense premise and the visual premise and derives a final conclusion through a logical association with the at least one intermediate conclusion (stage S350).

In stage S310, the visual premise unit 110 may detect and decide the visual premise necessary for the argumentation from the image.

In stage S330, the commonsense premise unit 120 may extract background knowledge related to the visual premise and decide the commonsense premise based thereon.

In stage S350, the conclusion derivation unit 130 may derive an intermediate conclusion based on the visual premise and the commonsense premise, and analyze the logical association between these intermediate conclusions to derive the final conclusion.

### 1. VisArgs Dataset

VisArgs includes a total of 1,611 images featuring clear visual argumentation. These images are categorized into 914 advertisement images and 697 cartoon images according to their sources. Each image in VisArgs is annotated with a description of the visual premise (VP), a bounding box, a description of the commonsense premise (CP), a conclusion, and an argumentation tree (T) detailing the inference path from the premise to the conclusion (C). The average character lengths of VP, CP, C, and T are 79, 91, 142, and 105, respectively. On average, each image includes 3.17 visual premises, 3.46 commonsense premises, and 2.88 intermediate conclusions.

### 1.1. Annotation Process

GPT-4-O (Achiam et al., 2023) was utilized partially on the initial annotation task. However, these machine generated annotations serve only as preliminary work, which are then extensively refined by experienced human workers. The machine's role is merely to provide imperfect starting points to facilitate the human annotation work. Hereinafter, the annotation procedure is described in detail.

### Collecting Images.

The primary criterion was to select images that enable human annotators to easily and accurately interpret both the visual premise and the corresponding conclusion in the image, thereby clarifying the argumentative structure within the image. In addition, samples with scene text that directly describe the conclusion were ruled out. Around 1,600 images were manually collected following these criteria from Pinterest. Starting with keyword-based searches such as creative ads, the collection was expanded by exploring related images. Cartoons (which often contain visual argumentation (Birdsell and Groarke, 1996)) were sourced from a dedicated website. Around 1,600 cartoons were manually collected from various categories, including politics, education, and environment. URLs were included to the images to comply with licensing terms following previous task (Schuhmann et al., 2022; Lee et al., 2021).

### Describing Visual Premises.

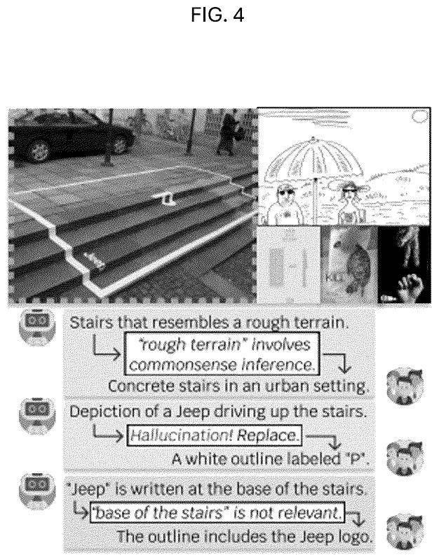

The next stage is to explicitly describe the visual argumentation within each image. However, during the early stages of the annotation task, it was discovered that although humans may naturally understand visual argumentation, the humans often find it challenging to articulate their interpretation into structured argumentation trees. Accordingly, an AI model (GPT-4-O) was used to generate initial candidate annotations. Human workers then select and modify these initial annotations, as shown in FIG. 4. The human annotators might optionally incorporate new visual premises when necessary. This expanded the scope of the visual premise to about 21% of the total image. To facilitate this process, the annotation task was broken down into two stages: describing the visual premises and specifying the argumentative structure.

Given an image containing visual argumentation, the model was instructed to generate a set of visual premises necessary to support the argumentation. However, the AI model often fails to fully comprehend the visual argumentation. To address this, a pool of experienced human workers was engaged to review the machine generated outputs. The workers selected the correct visual premises and made necessary modifications to ensure accuracy and coherence. Additionally, a model-generated visual premise sometimes contains multiple individual premises. The reviewers were instructed to separate these merged premises into individual atomic premises.

### Specifying Argumentative Structure

Given the visual premises and the image, three components constituting the argumentative structure are further annotated: commonsense premises, conclusions, and argumentation trees. As in the previous stage, initial candidates were first generated using an AI model. For this stage, an additional criterion was imposed: the set of selected premises need to be both necessary and complete. The same pool of human workers then adjust the annotations for greater accuracy. The workers first verify the correctness of the conclusion and discard the image when the conclusion is incorrect. The workers then identify and correct any errors, including semantic and structural mistakes. Among a total of 3,204 images, 1,593 images were discharged in this process.

### Visual Grounding.

Lastly, bounding box annotations were manually gathered for each visual premise to finalize the multimodal annotation task. It is assumed that there is a one-to-one relationship between each bounding box (vpr_i) and the corresponding textual description (vpd_i). Annotators are instructed to ensure accurate matching and precise bounding box tightness.

### 1.2. Data Analysis

### Topic Diversity

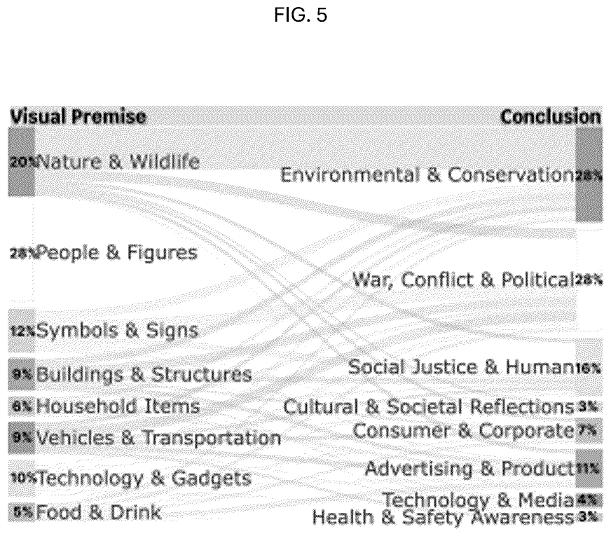

To gauge the diversity of topics covered in VisArgs, zero-shot categorization using GPT-4-O and LLaMa3 (AI@Meta, 2024) was utilized to classify the topics of visual premises and conclusions. As a result, it was identified that the topics cover a wide range of visual objects and argumentation topics. FIG. 5 shows details thereof.

Visual Cues Vs. Dense Captioning

In theory, selective attention to visual premises might be collapsed into an NLP problem in a way that details every element of the image. To test this counter-hypothesis, it was manually checked how often the visual premises are contained in the outputs of detailed captioning models. Three reference models are included herein: a general model (LLaVA-Next (Liu et al., 2024b)), a specialist model (ShareCaptioner (Chen et al., 2023)), and LLaVA LLaMa3 (XTuner Contributors, 2023) fine-tuned on a detailed captioning corpus (DOCCI (Onoe et al., 2024)). Table 2 summarizes a manual review result of 100 images, showing that the detailed captions insufficiently capture the visual premises, with the hit rate staying below 15% for all models.

TABLE 2
Frequency of detailed captions containing visual
premises. Hit rate denotes how often all visual
premises per image are included in the captions.

| | Recall | Hit rate |
|---|---|---|
| LLaVaNeXT | 0.48 | 0.14 |
| LLaVa-LLaMa3-Docci | 0.27 | 0.02 |
| ShareCaptioner | 0.40 | 0.12 |

### Safety

Since safety was not initially filtered, the safety of VisArgs was analyzed using standard models. For textual safety, the Perspective API7 was used, and for visual domains, LAION-Safety8 was utilized. The toxicity scores for textual descriptions were 0.03 for visual premises and 0.07 for conclusions. In addition, given the threshold of 0.7, no descriptions and visual premises were classified as toxic. Furthermore, only 71 among 1611 images are classified as unsafe. Manual review result reveals that such “unsafe” images were social campaigns advocating against the harmful behaviors which presumably triggered the LAION detector.

### 2. Task Overview

Three tasks were posed based on VisArgs for a structured analysis of how machines understand argumentation presented in visual form.

Each instance of VisArgs consists of an image I, a set of visual premises VP={(vpd₀, vpr₀), (vpd₁, vpr₁), . . . } with textual description vpd along with region grounding with a bounding box vpr=<x, y, h, w>, a set of commonsense premises CP={cpd₀, cpd₁, . . . }, and the conclusion in textual form C. A single argumentation tree for each image is built on the premises. Each tree t∈T represents a reasoning path leading to the conclusion C. The nodes N of a tree consist of the following components.
Leaf nodes: subsets of the union of the visual and commonsense premises VP∪CP.
Internal nodes: elements of the set of intermediate conclusions IC.
Root node: the final conclusion C.
An edge e of the tree connects a subset of nodes N̅⊂VP∪CP∪IC to either an intermediate conclusion ic∈IC or the final conclusion C.

### 2.1 Localization of Premises

The first task focuses on assessing whether machines may accurately align visual premises (VPd) with the corresponding regions (VPr) in a given image I. The task aims to check whether difficulties in understanding visual argumentation originate from basic object detection stages, and requires minimal computational reasoning capabilities.

Two setups were investigated based on the algorithm's ability to output bounding box labels.

### Closed-Set Grounding

Closed-set grounding is designed for a broad range of models that lack explicit grounding capabilities. The problem is formulated as a retrieval task where the goal is to match a specific region in the image vprᵢ with an appropriate description vpdᵢ. Standard image-text matching models such as CLIP were adapted to perform grounded image-text matching.

### Open-Set Grounding

Open-set grounding tests models with explicit grounding capabilities. The task is framed as a visual grounding problem (Yu et al., 2016), where the machine requires locating an object in an image based on a natural language expression. Both the ground truth and machine output are represented as bounding box coordinates <x, y, h, w>. Performance is evaluated using the intersection over union (IoU) ratio, with predictions considered correct if IoU≥0.5.

### 2.2 Identification of Premises

The second task tests the machines' capabilities to discern visual premises that would better support the given conclusion. Given the image I, the intermediate conclusion ic, and a superset of the text descriptions of the visual premises S⊃VPd, the machine needs to retrieve a correct visual premise vpdᵢ∈VPd. The candidate set S contains a single ground truth premise vpdᵢ and a fixed number K=2 of negative premises.

The complexity of a retrieval task is impacted by the choice of the set of negative premises. To this end, four types of global samplers and a single local sampler were explored for constructing the set of negative premises. The global samplers source the negative premises from visual premises that do not correspond to the selected image. The difference of each sampler is the sample selection strategy.

Random sampling extracts samples uniformly without replacement.

Visual sampling extracts samples from the top premise descriptions that are the closest to the given image. CLIPScore (Hessel et al., 2021) was used for the multimodal scoring.

Textual sampling extracts samples from the top premise descriptions that are the closest to the truth premise. Cosine similarity on the ColBERT (Khattab and Zaharia, 2020) representation space was used for the textual scoring.

Mixed sampling combines textual and visual sampling by selecting the most visually similar items from the top 10 textual retrieval results.

For local sampling, a negative premise was selected from the visual premises that correspond to the selected image. Relying on the argumentation tree annotation, the set of local visual premises that does not help justify the intermediate conclusion ic was automatically secured. Samples were uniformly extracted without duplicates from the local pool, and this method was named semantic sampling. Additionally, human performance on 100 random samples was reported to mitigate the risk of false negatives.

### 4.3 Deduction of Conclusion

The third task is to evaluate how each component (I, VP, CP, IC, and T) influences the deduction of the conclusion C. This was approached as a sequence-to-sequence task aimed at generating C. While this method allows flexible output formats, it complicates evaluation because the machine-generated text needs to be compared to the free-form label. Common text comparison practices, such as BLEU (Papineni et al., 2002), ROUGE (Lin, 2004), and CIDEr (Vedantam et al., 2015) measure surface form similarity, not semantic similarity between conclusions.

Alternatively, prompt-based evaluation using general reasoners (GPT-4) (Achiam et al., 2023) may be biased by factors including candidate order (Pezeshkpour and Hruschka, 2023). Ideally, human verification is the most suitable, but is costly and hard to reproduce. A small-scale comparison study (see Table 3) was conducted to verify that the model-based metric BERTScore (Zhang* et al., 2020) provides the most stable estimate, making it the primary evaluation metric.

TABLE 3
Correlation of each metric with human decisions
in the Deduction of Conclusion task.

| | Acc. | Prec. | Rec. | FI | Corr. (ρ) |
|---|---|---|---|---|---|
| BLEU-4 | 67 | 44 | 67 | 53 | 18 |
| ROUGE | 75 | 76 | 75 | 72 | 35 |
| CIDEr | 72 | 70 | 72 | 70 | 26 |
| GPTEval | 75 | 83 | 75 | 76 | 53 |
| BERTScore | 94 | 94 | 93 | 93 | 59 |

### 3. Experiments

### 3.1. Localization of Premises

Localization of Premises evaluates the visual grounding capabilities of machines. Given the image I and description of a visual premise vpd, the goal is to find a corresponding region vpr in the image.

### Metrics and Models

Open-set evaluation is defined as a setting in which models are required to generate bounding box coordinates without relying on a predefined candidate list. Accordingly, models used for open-set and closed-set evaluations are structurally distinct, since models lacking a generative head, such as CLIP (Radford et al., 2021), are not compatible with open-set evaluation due to their dependence on a candidate region list for text-to-region matching.

For closed-set grounding, which is an N-way classification task, the goal is to match the given description with the correct bounding box. To evaluate standard image-text matching algorithms (e.g. CLIP), the corresponding regions were cropped accordingly. The models for this task include various CLIP-based models (CLIP (Radford et al., 2021) with different back bones and SigLIP (Zhai et al., 2023)) and a multitask model OFA (Wang et al., 2022). The CLIP based models are adapted as follows. For each candidate object region (specified by bounding box coordinates), the corresponding regions are cropped from the image to create region-level image representations. Image features for each cropped region are then extracted using a CLIP-based encoder, while text features are obtained by encoding the text description using the same model. Cosine similarity is calculated between the text feature and each region-level image feature. The region with the highest similarity score is selected as the predicted match.

For open-set grounding, which is to locate an object in an image based on a natural language expression. The models were instructed to output bounding box coordinates and compare the same to the truth region. A predicted coordinate is considered correct if its intersection over union with the gold label is at least (IoU≥0.5). There included a diverse set of models that support local region output formats, UNINEXT-H (Yan et al., 2023), LISA (Lai et al., 2023), Unified-IO-2 (Lu et al., 2023), OFA, MM-G-DINO (Liu et al., 2023b).

### Results

Table 4 demonstrates that current models are generally effective in matching descriptions of visual premises to the correct regions in images, thereby meeting the basic vision requirements for understanding visual argumentation. However, the results for open-set grounding, shown in Table 5, are somewhat mixed: the scores are acceptable but not uniformly high. It is traced this performance decline to the nature of zero-shot object detectors, which are designed to detect concrete objects and clear segments. In contrast, the bounding boxes of VisArgs are more semantic (reflecting conceptual boundaries rather than segmentation purposes) (Guo et al., 2018).

TABLE 4
closed-set results in localization of premises.

| | Acc. (%) | | |
|---|---|---|---|
| | Ads | Cartoon | All |
| Random | 33.33 | 33.33 | 33.33 |
| Human | 100.00 | 100.00 | 100.00 |
| CLIP [symbol] | 80.83 | 82.72 | 81.91 |
| CLIP [symbol] | 82.72 | 82.96 | 82.85 |
| CLIP [symbol] | 82.09 | 83.26 | 82.76 |
| SigLIP | 86.10 | 86.67 | 86.43 |
| AlphaCLIP | 75.15 | 77.44 | 76.45 |
| OFA [symbol] | 68.75 | 75.71 | 72.71 |
| OFA [symbol] | 72.01 | 79.18 | 76.10 |

[symbol]

indicates data missing or illegible when filed

TABLE 5
open-set results in localization of premises.

| | IoU | Acc. (%) |
|---|---|---|
| UNINEXT-H | 38.75 | 35.58 |
| LISA | 44.25 | 44.62 |
| Unified-IO-2 | 48.61 | 47.15 |
| OFA | 50.14 | 49.13 |
| MM-G-Dino | 55.02 | 54.98 |

### 3.2. Identification of Premises

Identification of Premises tests the selective attention capabilities, that is, selecting necessary visual cues to understand argumentation. Given the image I and an intermediate conclusion ic, the goal is to select a visual premise vpd that leads to this intermediate conclusion.

### Metrics and Models

For this task, only intermediate conclusions that have at least two unrelated visual premises within the image were retained. Classification accuracy was reported based on a single gold visual premise and two negative candidates. The negative sets are categorized into random, visual, textual, mixed, and semantic sets.

Given the task's requirement for understanding argumentative structure, the models evaluated are primarily multimodal large language models (LLMs) with adequate reasoning capabilities. The models used for experiments include OFA (Wang et al., 2022), Qwen-VL Chat (Bai et al., 2023), CogVLM (Wang et al., 2023), Idefics2 (Laurengon et al., 2024), Instruct BLIP (Dai et al., 2024), Unified-IO 2 (Lu et al., 2023), LLaVa-1.5 (Liu et al., 2024a), and LLaVa Next (Liu et al., 2024b).

### Results

Table 6 highlights a significant trend. Models struggle to distinguish negative premises within the image (local), but excel in identifying global negative premises. A major challenge for most models was handling semantic negative premises within the same image, as evidenced by the wide margin between models' performance on global and local setups. Still, the global negative samples exhibited more pronounced distinctions based on their sampling scheme. Negative premises sampled uniformly were distinguishable by most models with ≥90% accuracy.

In contrast, negative premises using retrieval methods provided a more challenging task across the board, particularly for negative premises retrieved using the text-to-text similarity model (textual), which increased the problem complexity for most models. Notably, OFA failed to follow zero-shot instructions for multiple-choice answering, scoring close to zero.

Finally, results using images of actually cropped bounding box regions were presented. Although cropped images are not lossless representations of the regions, all models exhibited significant improvements in performance, indicating that the ability to infer relevant visual cues is a critical task. Thus, it was concluded that models struggle to infer which visual cues support the argumentation.

TABLE 6
Results of the Identification of Premises task. Difference between the
lowest score in global and local setup for each model are highlighted.

| | Global | | | | Local | |
|---|---|---|---|---|---|---|
| | Random | Visual | Textual | Mixed | Semantic | Semantic |
| Random | 33.33 | 33.33 | 33.33 | 33.33 | 33.33 (—) | |
| Human | 100.00 | 99.00 | 94.00 | 100.00 | 98.00 (↑ 4.00) | +G.T region |
| OFA | 0.00 | 0.00 | 0.00 | 0.00 | 0.00 (—) | — |
| Qwen-VL-Chat | 86.05 | 85.77 | 70.67 | 75.57 | 49.74 (↓ 20.93) | — |
| CogVLM | 97.46 | 96.39 | 88.00 | 92.22 | 65.31 (↓ 22.69) | — |
| Idefies2 | 98.68 | 97.83 | 91.80 | 95.07 | 75.01 (↓ 16.79) | — |
| InstructBLIP | 83.77 | 79.23 | 66.95 | 71.37 | 61.90 (↓ 5.05) | 78.13 (↑ 16.23) |
| Unified-IO-2 | 98.42 | 96.99 | 86.87 | 92.81 | 34.74 (↓ 52.13) | 84.39 (↑ 49.65) |
| LLaVA-1.5 | 98.65 | 97.91 | 83.74 | 89.86 | 67.43 (↓ 16.31) | 76.67 (↑ 9.24) |
| LLaVA-NeXT | 97.66 | 96.20 | 80.90 | 85.86 | 78.53 (↓ 2.37) | 82.19 (↑ 3.66) |
| GPT-4-O | — | — | — | — | 79.50 (—) | — |

### 3.3. Deduction of Conclusion

Deduction of Conclusion evaluates the comprehensive ability to deduce the conclusion of argumentation. Given a subset of inputs among the image I, the visual premises VP, the commonsense premises CP, and the reasoning tree T, the objective is to generate the conclusion C of the argumentation.

### Metrics and Models

BERTScore was used as the primary metric. The models tested include all the multimodal LLMs used in the previous experiment and text-only LLMs (LLaMa-3-Instruct (AI@Meta, 2024), Mistral-Instruct (Jiang et al., 2023), and Zephyr (Tunstall et al., 2023)). All LLMs used herein are the 7-8b sized variants. The LLMs do not take the image as an input.

### Results

Table 7 shows the results. As expected, most models showed the greatest performance improvement when provided with the ground-truth set of visual premises. This supports that selective attention to visual premises is an important bottleneck in understanding visual argumentation in current models. In addition, both multimodal and text-only models improved performance with additional information from commonsense premises and reasoning trees in most setups, indicating that models may not perfectly understand visual argumentation in a text only format and benefit from explicit reasoning process information.

OFA struggled to follow the instruction format, leading to sub zero scores. Although rare, BERTScore, based on cosine similarity, may yield negative values. The multimodality of the deduction of conclusion task resides in the visual premises, making it solvable by text-only models given the information.

TABLE 7
Results of the Deduction of Conclusion task, showing how incremental
additions of inputs affect the correctness of the conclusion.
Scores are presented using BERTScore, with similar trends observed
across other metrics as detailed in Appendix F.

| | Image | +VP | | +CP | | +Tree | |
|---|---|---|---|---|---|---|---|
| LLaMA3 | — | 30.2 | | 37.8 | (↑7.6) | 40.8 | (↑2.0) |
| Mistralv0.2 | — | 18.9 | | 30.2 | (↑11.3) | 36.6 | (↑6.4) |
| Zephyr | — | 20.6 | | 28.7 | (↑8.1) | 36.5 | (↑7.8) |
| OFA | −41.3 | −24.6 | (↑16.7) | −16.5 | (↑8.1) | −13.9 | (↑2.6) |
| Qwen-VL- | 12.8 | 23.7 | (↑10.9) | 30.2 | (↑6.5) | 32.7 | (↑2.5) |
| Chat | | | | | | | |
| CogVLM | 25.7 | 30.7 | (↑5.0) | 33.6 | (↑2.9) | 36.3 | (↑2.7) |
| Idefics2 | 16.4 | 22.8 | (↑6.4) | 29.5 | (↑6.7) | 36.6 | (↑7.2) |
| InstructBLIP | −18.4 | 16.6 | (↑35.0) | 28.9 | (↑12.3) | 32.2 | (↑3.3) |
| Unified-IO-2 | −9.9 | −3.4 | (↑6.5) | 4.2 | (↑7.6) | 8.0 | (↑3.8) |
| LLaVA-1.5 | 2.2 | 20.0 | (↑17.8) | 29.6 | (↑9.6) | 33.7 | (↑4.1) |
| LLaVA-Next | 15.1 | 28.4 | (↑13.3) | 34.3 | (↑5.9) | 39.5 | (↑5.2) |

| | | | | | | |
|---|---|---|---|---|---|---|
| GPT-4-O | 25.5 | — | 34.3 | (↑8.8) | 41.0 | (↑6.7) |

### 3.4. Diagnostics

### Prompt Robustness

To ensure the robustness of empirical results, the prompts provided to the models were differentiated. As shown in Table 8, the trend of performance improvements remained stable across four different prompts, identifying the validity of tests.

### Error Analysis

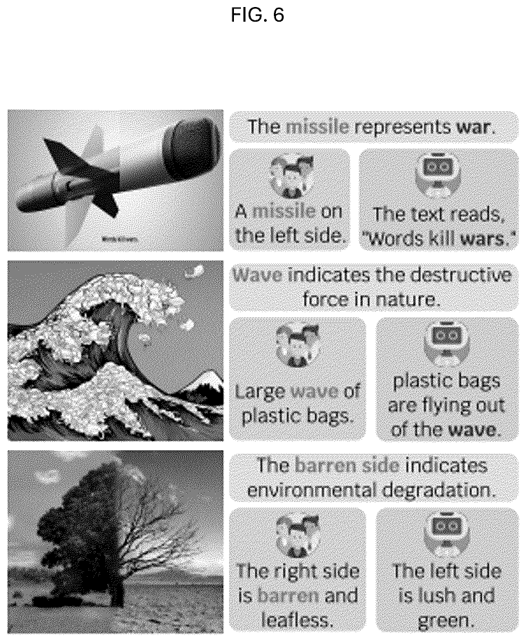

FIG. 6 provides qualitative examples of failure cases. Instances are presented straightforward to clearly explain the errors. In these cases, the models fail to reason about the relevant object, which is the subject of the given intermediate conclusion, and instead rely on common words, leading to incorrect reasoning results.

### Reliance on OCR Capabilities

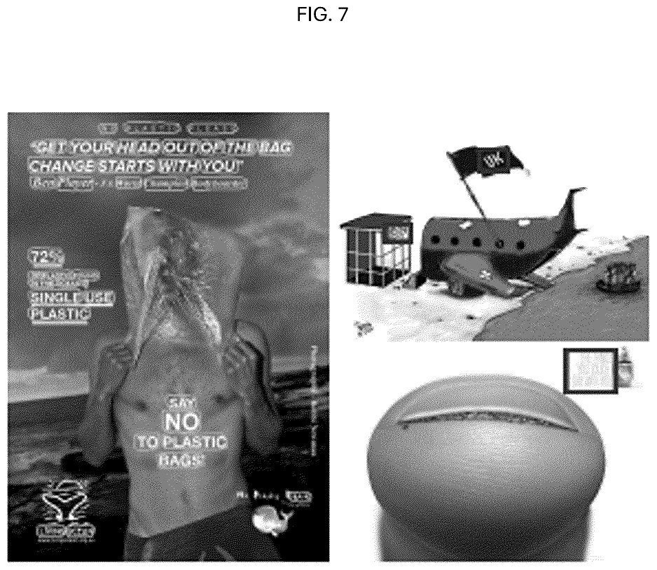

To evaluate how demanding VisArgs is on OCR capabilities, a lightweight OCR detector (Du et al., 2021) was used to detect bounding boxes of the visual premises without leveraging text annotations as input. Even this simplified model achieves 82.77% accuracy in image-wise evaluation, where an image is considered correctly detected only if all visual premises therewithin are identified. Typical failure cases are illustrated in FIG. 7.

Although the above has been described with reference to preferred embodiments of the present disclosure, those skilled in the art will understand that various modifications and changes may be made without departing from the spirit and scope of the present disclosure as described in the claims below.
[National Research and Development Project Business Supporting the Present Disclosure]
[Project Serial Number] 2710006677
[Project Number] RS-2020-II201361
[Related Department] Ministry of Science and ICT
[Research Management Specialized Agency] Institute for Information & Communications Technology Planning & Evaluation (IITP)
[Research Project Business Title] Information, Communications, and Broadcasting Innovation Talent Nurturing Project (R&D)
[Research Project Title] Artificial Intelligence Graduate School Program (Yonsei University)
[Lead Institute] University Industry Foundation, Yonsei University
[Research Period] Jan. 1, 2024 to Dec. 31, 2024

### DETAILED DESCRIPTION OF MAIN ELEMENTS

100: visual argumentation reasoning device
110: visual premise unit
120: commonsense premise unit
130: conclusion derivation unit

What is claimed is:

1. A visual argumentation reasoning device, comprising:
a visual premise unit (VPU) that receives an image and detects an argumentation premise from the image to decide a visual premise;
a commonsense premise unit (CPU) that extracts at least one piece of background knowledge associated with the visual premise to decide a commonsense premise; and
a conclusion derivation unit that derives at least one intermediate conclusion based on the commonsense premise and the visual premise and derives a final conclusion through a logical association with the at least one intermediate conclusion.

2. The device of claim 1, wherein the visual premise unit detects an object from the image and decides an argumentation premise object by determining whether the detected object is able to be used as the argumentation premise.

3. The device of claim 2, wherein the visual premise unit evaluates a possibility of the argumentation premise based on at least one of a shape, color, size, and texture features of the detected object.

4. The device of claim 3, wherein the visual premise unit evaluates the possibility of the argumentation premise based on an object disposition relationship considering a location of the detected object within the image.

5. The device of claim 2, wherein the visual premise unit evaluates the possibility of the argumentation premise based on whether the detected object includes text or symbols.

6. The device of claim 2, wherein the visual premise unit decides the visual premise by performing semantic clustering through analyzing a similarity to the argumentation premise object.

7. The device of claim 1, wherein the commonsense premise unit generates a textual representation of the visual premise and extracts candidate background knowledge by searching the textual representation in a knowledge base.

8. The device of claim 7, wherein the commonsense premise unit evaluates logical validity of the candidate background knowledge for the visual premise to decide the at least one piece of background knowledge.

9. The device of claim 8, wherein the commonsense premise unit decides the commonsense premise by calculating correlation of the visual premise to each of the at least one piece of background knowledge.

10. The device of claim 8, wherein the conclusion derivation unit decides a logical order of the at least one intermediate conclusion and performs selection and ruling out of the at least one intermediate conclusion in a process of deciding the logical order to integrate the at least one intermediate conclusion.

11. A visual argumentation reasoning method performed by a visual argumentation reasoning device, the method comprising:
a visual premise stage that receives an image and detects an argumentation premise from the image to decide a visual premise;
a commonsense premise stage that extracts at least one piece of background knowledge associated with the visual premise to decide a commonsense premise; and
a conclusion derivation stage that derives at least one intermediate conclusion based on the commonsense premise and the visual premise and derives a final conclusion through a logical association with the at least one intermediate conclusion.
